(19) United States
(12) Patent Application Publication
(10) Pub. No.: US 2002/0191691 A1
(43) Pub. Date: Dec. 19, 2002

(54) Payload header suppression including removal of fields that vary in known patterns

(76) Inventor: Clive Eric Holborow, San Diego, CA (US)

Correspondence Address: EDWARD W CALLAN, NO. 705 PMB 452, 3830 VALLEY CENTRE DRIVE, SAN DIEGO, CA, 92130, US

(21) Appl. No.: 09/853,422

(22) Filed: May 10, 2001

(51) Int. Cl. H04B 1/66

(52) U.S. Cl. 375/240

(57) ABSTRACT

A CM terminal uses a predetermined suppression algorithm for removing a field that varies in a known pattern from a payload header of an information packet being transmitted to a remote CMTS terminal; and the CMTS terminal uses a predetermined restoration algorithm that is complementary to the predetermined suppression algorithm for restoring the removed field to the payload header of an information packet received from the CM terminal. The CM terminal and the CMTS terminal process and exchange service control messages that include DOCSIS PHS encoding extensions identifying the variable fields that are to be removed from the payload headers of discrete information packets and indicating respective schemes for restoring the identified variable fields and further include suppression-enable-flag values for the variable fields, to thereby define pertinent parameters of the suppression and restoration algorithms.

### BACKGROUND OF THE INVENTION

The present invention generally pertains to compression and decompression of digital signal information packets transmitted from a first terminal to a second terminal and is particularly directed to suppression of the payload header of the information packets.

An Acronym Glossary is provided herein at the end of the Detailed Description.

The DOCSIS Radio Frequency (RF) Interface Specification 1.1 includes a simple prior art payload header suppression (PHS) scheme that allows suppression of header octets that have the same fixed values in every transmitted packet. A PHS rule may be defined for a given connection between a transmitting terminal and a receiving terminal by an initializing DOCSIS service control message exchange so that both the transmitting terminal and the receiving terminal know which octets are to be suppressed, and their respective values. Once defined, the PHS rule normally remains fixed for the duration of a connection while the current codec or signal source is in use. Since a change in the codec or signal source will require a DOCSIS Dynamic Service Change message sequence, a new PHS rule can be defined with new values appropriate to the new codec or the new signal source.

According to the prior art DOCSIS PHS scheme, the suppressed octets are removed just prior to transmission on the DOCSIS link and restored immediately after reception. The DOCSIS PHS scheme is lossless (in that the exact original packet is reconstructed) and suppresses the same number of octets from each transmitted packet. If the original packets are all the same length (as it typical for VoIP), then so are the transmitted packets. This property distinguishes the DOCSIS PHS scheme from other well-known IP header compression schemes (RFC-1144, RFC-2507, RFC-2508) and makes it particularly suitable for use with DOCSIS unsolicited grant scheduling (UGS) upstream bandwidth allocation. UGS supplies periodic fixed length transmission opportunities, and is intended to carry services like telephony, which transmit fixed amounts of data on a periodic schedule and require low latency.

However, there are several fields in the payload headers of information packets commonly used for IP telephony and other services which do not remain fixed in value but which vary in a known pattern. These fields cannot be suppressed and then restored by using the prior art DOCSIS PHS scheme.

### SUMMARY OF THE INVENTION

The present invention provides a system for compressing and decompressing information packets transmitted from a first terminal to a second terminal, comprising suppression means in the first terminal adapted to use a predetermined suppression algorithm for removing at least one field that varies in a known pattern from a payload header of an information packet being transmitted to the second terminal; and restoration means in the second terminal adapted to use a predetermined restoration algorithm for restoring the removed at least one field that varies in the known pattern to the payload header of an information packet received from the first terminal; wherein the first and second terminals respectively include means for processing and exchanging service control messages that include encoding extensions identifying the removed at least one field that varies in the known pattern and indicating a scheme for restoring the identified at least one field; and wherein for discrete transmitted information packets, the predetermined restoration algorithm includes the step of: restoring the at least one identified removed field that varies in the known pattern in accordance with the scheme for restoring the identified at least one field indicated by the encoding extensions.

In another aspect, the present invention provides a system for compressing and decompressing information packets transmitted from a first terminal to a second terminal, comprising suppression means in the first terminal adapted to use a predetermined suppression algorithm for removing at least one field that varies in a known pattern from a payload header of an information packet being transmitted to the second terminal; and restoration means in the second terminal adapted to use a predetermined restoration algorithm for restoring the removed at least one field that varies in the known pattern to the payload header of an information packet received from the first terminal; wherein the predetermined restoration algorithm includes the step of: from time to time restoring the at least one removed field that varies in the known pattern by using an associated refresh field received with the information packet.

The present invention also provides apparatus for compressing information packets for transmission to a remote terminal and apparatus for decompressing transmitted information packets received from a remote terminal in accordance with various aspects of the system of the present invention.

Additional features of the present invention are described with reference to the detailed description of the preferred embodiments.

### BRIEF DESCRIPTION OF THE DRAWING

FIG. 1 is a block diagram of a system according to the present invention.

FIGS. 2A and 2B in combination show a flow diagram of a payload-header-suppression algorithm for a preferred embodiment of the present invention.

FIGS. 3A and 3B in combination show a flow diagram of a payload-header-restoration algorithm for a preferred embodiment of the present invention.

### DETAILED DESCRIPTION

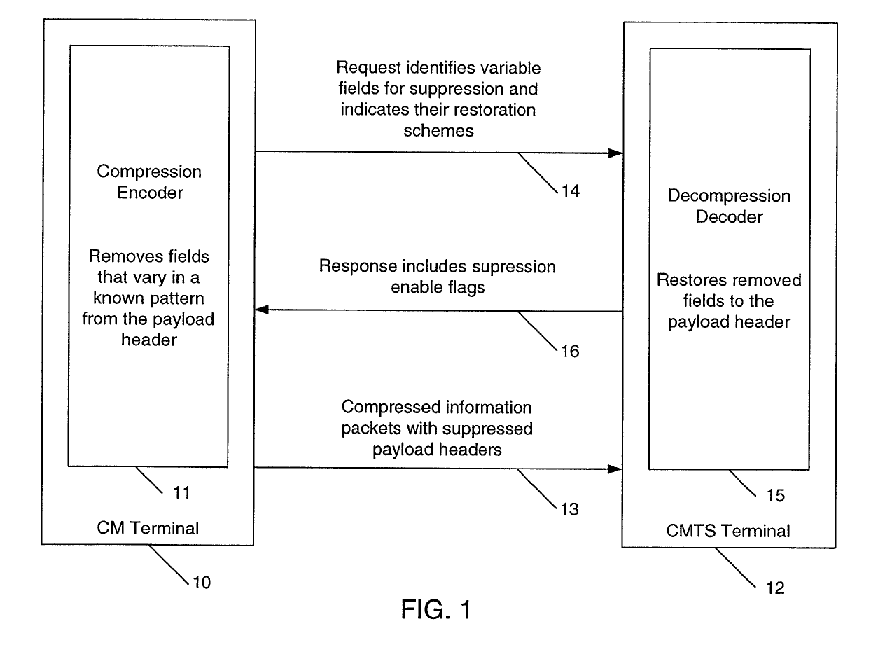

Referring to FIG. 1, a preferred embodiment of the system of the present invention includes a first terminal 10 that includes a compression encoder 11 for compressing information packets and a second terminal 12 that includes a decompression decoder 15 for decompressing compressed information packets. The first terminal 10 transmits compressed constant-length information packets 13 with suppressed payload headers to the second terminal 12.

In accordance with the terminology of DOCSIS Radio Frequency (RF) Interface Specification 1.1, the first terminal 10 is referred to herein as a CM (cable modem) terminal and the second terminal 12 is referred to herein as a CMTS (cable modem termination system) terminal. In a preferred embodiment (not shown), the CMTS terminal 12 further includes a compression encoder as described herein for compressing information packets transmitted to the CM terminal 10, and the CM terminal 10 further includes a decompression decoder as described herein for decompressing compressed information packets received from the CMTS terminal 12. The compression encoder and the decompression decoder are implemented by either dedicated hardware or a computer that is adapted by computer programming.

The compression encoder implements a predetermined suppression routine that applies the prior art DOCSIS PHS scheme of DOCSIS Radio Frequency (RF) Interface Specification 1.1 for removing the fixed-value fields from the payload headers of discrete information packets being transmitted to a remote terminal, such as the CMTS terminal 12; and the decompression decoder implements a predetermined restoration routine that applies the same prior art DOCSIS PHS scheme for restoring the removed fixed-value fields to the information packets received from a remote terminal, such as the CM terminal 10.

The compression encoder implements a predetermined suppression algorithm for removing at least one field that varies in a known pattern from the payload header of discrete information packets being transmitted to the remote terminal CMTS terminal 12; and the decompression decoder implements a predetermined restoration algorithm that is complementary to the predetermined suppression algorithm, for restoring the removed field(s) to the payload header of an information packet received from the remote CM terminal 10.

The values of several of the fields to be suppressed increment by known amounts in successive packets. To allow the decompression decoder to compensate for lost packets, a 4-bit packet continuity count is carried in bits 0-3 of a PHS control field that is transmitted with each information packet.

The parameter definitions for a DOCSIS PHS rule implementing the predetermined suppression algorithm and the predetermined restoration algorithm are identified in a service control message exchange between the CM terminal 10 and CMTS terminal 12 upon initiation of a connection for transmitting information packets. These parameter definitions include PHS encoding extensions that identify the variable fields that can be removed from the payload headers of discrete information packets in accordance with the predetermined suppression algorithm and indicate respective schemes for restoring the identified variable fields. Additional encoding extensions within this service control message exchange include suppression enable flags related to the variable fields that can be removed. The identified variable fields include fields that vary in accordance with a known pattern, to wit: the IP Identification field, the RTP Sequence Number field, the RTP Timestamp field and RTP Octet 2 field. There are situations when these last three fields cannot be suppressed for UGS service flows when an audio codec with silence suppression is being used.

The IP Identification field is usually implemented as a count; but sometimes it increments by more than one. This field is used to collect fragments of a fragmented IP packet; whereby it is not needed when there is no IP fragmentation. It is uncertain whether this field can be set to a fixed value, because RFC-791 does not define this possibility. Some IP stack implementations may not tolerate a fixed value in this field. In the upstream packets (from a CM terminal to a CMTS terminal), this field can readily be generated at the CMTS terminal by a counter with an arbitrary start value which increments for each packet. An easy alternative is to copy the RTP Sequence Number. In downstream packets (from a CMTS terminal to a CM terminal) it can be delta encoded using schemes described in the identified RFCs. The value of this field is included in the IP Checksum; whereby the IP Checksum must be calculated after the IP Identification field value is set. If IP Checksums are being carried in the packets, the IP Identification field starting value must be conveyed to the decompression decoder and refreshed from time to time. If the IP Identification field can be set to zero or some other fixed value, then both the IP Identification field and the IP Header Checksum field can be by suppressed by using the predetermined suppression algorithm for both upstream and downstream packets.

The value of the RTP Sequence Number field increments for each transmitted RTP packet. The start value is arbitrary; whereby if the UDP Checksum is not used, this field can be suppressed and generated by the decompression decoder, based only on the packet continuity count in the PHS Control field. In a downstream transmission, the packet continuity count must reflect any discontinuities in the RTP Sequence Numbers of packets received from a WAN. If UDP checksums are being carried in the packets the starting value of the RTP Sequence Number field must be transmitted to the decompression decoder as a Refresh Field for refreshing by the decompression decoder.

The RTP Timestamp field contains a value reflecting the value of the sampling clock for the first data sample being carried. The starting value of the timestamp field is arbitrary. For fixed frame voice codecs, this field increments by the number of samples represented in each packet. For video, this field increments by a suitable amount at the start of each frame, and remains constant for all packets carrying data from the same frame. For data that is transmitted in a different order than the order in which the data is displayed, such as interpolated video frames, the RTP Timestamp field does not increase monotonically, rather reflects the sampling time of the first sample in the frame. For voice, if the UDP Checksum is not used, the RTP Timestamp field can be suppressed and generated by the decompression decoder. If UDP checksums are being carried in the packets the RTP Timestamp field starting value must be transmitted to the decompression decoder as a Refresh Field for refreshing by the decompression decoder. If telephony signaling events encoded per RFC-2833 are being carried in a voice RTP packet stream, then it may not be possible to suppress the RTP Timestamp field because it will not increment uniformly. A special Refresh mode is provided to cope with many of these cases, and depending on the details of the implementation, suppression may be possible by examining the Payload Type field to determine which packets carry voice data.

For the RTP Octet 2 field, the Payload type identified by bits 0 through 6 reflects the codec being used, and is constant. The RTP Marker (bit 7) is set in accordance with the RTP profile being used. Some defined uses are that the Marker bit is set on the first packet of a talk burst when audio silence suppression is being used, and is set on the last packet of a video frame. For some codec types the RTP Octet 2 field is fixed; whereby it is possible to suppress this field in accordance with the predetermined suppression routine by using the prior art DOCSIS PHS scheme. If this field is not fixed, it still may be suppressed in accordance with a predetermined suppression algorithm, but one of the encoding extensions provides a fixed partial value of the RTP Octet 2 field and the variable remaining portion of the RTP Octet 2 field is provided by the Marker bit, which is carried in the PHS Control field.

Additional identified variable fields related to the suppression-enable flags include fields that can easily be calculated by the decompression decoder, to wit the IP header checksum and the UDP checksum.

The IP Header Checksum field is not normally needed for error detection because the Ethernet CRC (and Reed-Solomon code if used) are much more powerful error detection schemes, and both cover the IP Header. This field can be suppressed from both upstream and downstream-transmitted packets and calculated by the decompression decoder. This is a simple calculation over the 20 octets of the IP Header. If calculation at the decompression decoder is not acceptable then the IP Header Checksum must be carried in the packets, and the IP Identification field must retain the value it was given in the customer terminal.

The UDP Checksum field is calculated over the whole payload plus some of the IP address fields. Good network maintenance practice is to use this field as an end-to-end error check. If the UDP Checksum is not used, the RFC allows this field to be set to zero, whereby this field can be suppressed by using the prior art DOCSIS PHS scheme. If this field can be calculated by the CMTS terminal, some of the RTP header fields, which are covered by the UDP Checksum, can be suppressed in accordance with a predetermined suppression algorithm because the values will be set at the decompression decoder based on the packet continuity count. If this field cannot be suppressed, the RTP header fields must retain the values they are given in the CM terminal.

Upon initializing a connection between the CM terminal 10 and the CMTS terminal 12, the parameters of the predetermined suppression algorithm and the complementary predetermined restoration algorithm are defined by PHS extensions when the associated DOCSIS PHS rule is defined. Since the PHS extensions are extensions to the defined DOCSIS PHS rule, the DOCSIS PHS Index is used to identify both the DOCSIS PHS rule and the extensions. No new context identifier field (like the CID in RFC-2508) is needed.

For CM originated messages, the encoding extensions are encoded in vendor-specific PHS Parameter TLVs and included together with “off” values for the suppression-enable-flag extension within the PHS parameter definitions in a DSA-REQ or DSC-REQ service control message request 14 transmitted to the CMTS terminal 12.

The CMTS terminal 12 processes the DSA-REQ or DSC-REQ service message request 14 to determine whether the decompression decoder computer therein is adapted to use the predetermined restoration algorithm for restoring the variable fields respectively identified by the coding extensions in the request 14; and, if so, the CMTS terminal 12 indicates which of the identified variable fields can be restored by the decompression decoder computer by modifying the suppression-enable-flag extension in the request 14 to toggle appropriate flag values to “on”. If the decompression decoder computer therein is not so adapted, the suppression-enable-flag extension in the request 14 is not modified.

The CMTS terminal 12 then transmits to the CM terminal 10 a DSA-RSP or DSC-RSP service message response 16 including all of the encoding extensions received in the DSA-REQ or DSC-REQ service message request 14 and either the modified or the unmodified suppression-enable-flag extension.

The CM terminal 10 processes the suppression-enable-flag extension in the DSA-RSP or DSC-RSP service message response 16 received from the CMTS terminal to determine whether the decompression decoder in the CTMS terminal 12 is adapted to use the predetermined restoration algorithm for restoring the variable fields identified by the coding extensions in the request 14; and it is only when such processing determines that the decompression decoder in the CMTS terminal 12 is so adapted that the compression encoder in the CM terminal 12 is enabled to remove the identified variable fields from the payload header in accordance with the predetermined suppression algorithm. The roles of CM terminal 10 and CMTS terminal 12 are reversed when the CMTS terminal 12 sends a DSA-REQ or DSC-REQ service message request to the CM terminal 10 in the aforementioned preferred embodiment (not shown) in which each terminal 10, 12 includes both a compression encoder and a decompression decoder for compressing and decompressing information packets transmitted in both directions.

The predetermined suppression algorithm includes the step of removing one or more fields that vary in a known pattern from the payload header of a discrete information packet for transmission to the CMTS terminal 12. The predetermined restoration algorithm includes the step of (a) restoring the one or more removed fields that vary in respectively known patterns to the payload header of a compressed information packet received from the CM terminal 10 in accordance with the respectively identified restoration schemes indicated by the encoding extensions in the DSA-REQ or DSC-REQ service message request 14 received from the CM terminal 10.

In the preferred embodiment, the predetermined restoration algorithm further includes the step of (b) from time to time restoring a predetermined removed field to a discrete information packet by using an associated refresh field received with the discrete information packet 13 from the CM terminal 10; and for discrete information packets, the predetermined suppression algorithm includes the steps of: (c) in accordance with the encoding extensions, providing a refresh control field identifying a refresh field that is to be transmitted with the discrete information packet; (d) providing the refresh field identified by the refresh control field for transmission to the CMTS terminal 12 with the discrete information packet; and (e) providing a control field (the PHS Control field) that includes the refresh control field for transmission to the CMTS terminal 12 with the discrete information packet.

In this preferred embodiment, for discrete transmitted information packets, the predetermined restoration algorithm still further includes the step of: (f) in accordance with the transmitted refresh control field, identifying the associated refresh field received with the discrete information packet.

In this preferred embodiment, for discrete transmitted information packets, the predetermined restoration algorithm further includes the step of: (g) using the packet continuity count (in the PHS control field) in combination with the encoding extensions to restore the payload header when an information packet has been lost in transmission.

Also, in this preferred embodiment, one of the encoding extensions indicates a fixed partial value of the RTP Octet 2 field that is to be removed by the compression encoder; the control field also includes a Marker bit providing a variable remaining portion of the removed RTP Octet 2 field for transmission with the discrete information packet; and for discrete transmitted information packets, the predetermined restoration algorithm further includes the step of: (h) restoring the removed RTP Octet 2 field by using the variable remaining portion of the removed RTP Octet 2 field received with the discrete information packet in combination with the fixed partial value of the RTP Octet 2 field.

In the preferred embodiment, vendor specific PHS encoding extensions include the TLV types, lengths and values described below with reference to the following PHS extension fields.

PHS Extensions Version and Group Enable Flag

| Type | Length | Value | | |
|---|---|---|---|---|
| 1 | 2 | Octet 1: | 0x01 | (version number of this PHS scheme) |
| | | | 0x02 | (reserved for a similar PHS scheme that |
| | | | | uses only a single-byte refresh field) |
| | | | 0x03 | (reserved for a similar PHS scheme that |
| | | | | inverts the order of suppression of fixed |
| | | | | and varying fields) |

| | |
|---|---|
| Octet 2: | 0 = off (disabled) |
| | 1 = on (enabled) |

This field is used to identify the version of PHS, and to enable, as a group, all the PHS extensions specified in the Type 2 TLV described below. This field must be present in the Vendor Specific PHS Encoding. The predetermined suppression algorithm must not be used if this TLV is absent. This field is used to query the remote terminal to see if it can support the specified PHS extensions. The flag value of Octet 2 is set to zero (all PHS extensions disabled) in the DSA-REQ or DSC-REQ request message containing the PHS rule. The flag value of Octet 2 is set to 1 (on) in the DSA-RSP or DSC-RSP response message if the recipient remote terminal of the DSA-REQ or DSC-REQ request message can support all the PHS extensions in the DSA-REQ or DSC-REQ request message. If the recipient remote terminal of the DSA-REQ or DSC-REQ request message cannot support all the requested PHS extensions, it leaves flag value of Octet 2 is set to 0 (off) in the DSA-RSP or DSC-RSP response message. The protocol of version 0x01 does not allow the recipient remote terminal to accept only some of the requested PHS extensions, it must accept all of them or deny all of them.

PHS Extensions Individual Enable Flags

Type Length Value

2 2 bit 0: IP Identification field suppression

bit 1: IP Header Checksum field suppression

bit 2: UDP Checksum field suppression

bit 3: RTP Octet 2 suppression

bit 4: RTP Sequence Number suppression

bit 5: RTP Timestamp suppression

bits 6-15: reserved

For each flag, 0=disabled and 1=enabled. Bit zero is the LSB of the value field. This field must be present in the Vendor Specific PHS Encoding. This field is a set of bit flags to enable one or more of the PHS extensions. The value of each flag is set to zero in the DSA-REQ or DSC-REQ containing the PHS rule for each extension that the sender does not desire to use. The value of each flag is set to 1 in the DSA-REQ or DSC-REQ containing the PHS rule for each extension that the sender desires to use. If bit 0 is set to 1, the IP Identification field is suppressed and must be restored, updated, and refreshed as specified by TLV Type 3 below. If bit 1 is set to 1, the IP Header Checksum field is suppressed and it must be recalculated and reinserted by the decoder. If bit 2 is set to 1, the UDP Checksum field is being used but has been suppressed and it must be recalculated and restored by the decompression decoder. If the UDP checksum is not being used, then bit 2 will be set to zero and it will be suppressed using the prior art DOCSIS PHS scheme. If bit 3 is set to 1, the second octet of the RTP header is suppressed and the decoder must restore the Marker bit from the PHS Control Field. The other 7 bits of this octet are restored from the type 4 TLV encoding below. If bit 4 is set to 1, the RTP Sequence Number is suppressed and must be restored, updated, and refreshed as specified by TLV Type 5 below. If bit 5 is set to 1, the RTP Timestamp is suppressed and must be restored, updated, and refreshed as specified by TLV Type 6 below.

IP Identification Restoration

| Type | Length | Value |
|---|---|---|
| 3 | 1 | The value of the bits indicates the scheme for restoring |
| | | the IP Identification field, as shown in Table 1, below. |

TABLE 1

| TLV | | |
|---|---|---|
| Type 3 | | |
| Value | Initial Packet | Subsequent Packets |
| 0 | Use any arbitrary starting value | Increment field (as 16-bit |
| | for bits 4-15 and set bits 0-3 | counter) to keep bits 0-3 |
| | equal to the Continuity Count in | equal to the Continuity Count |
| | the PHS Control Field | in the PHS Control Field |
| 1 | Use value from refresh field if | Use value from refresh field if |
| | available, otherwise use any | available, otherwise increment |
| | arbitrary starting value for bits | field (as 16-bit counter) to |
| | 4-15 and set bits 0-3 equal to | keep bits 0-3 equal to the |
| | the Continuity Count in the PHS | Continuity Count in the PHS |
| | Control Field | Control Field |
| 2 | Set to zero | Set to zero |
| 3 (see | Set to value of RTP Sequence | Set to value of RTP Sequence |
| note) | Number | Number |

Note:
When the value of TLV Type 3 equals 3, then the RTP Sequence Number field must be restored first.

This field specifies the actions to be taken by the decompression decoder to restore the suppressed IP Identification Field. If this TLV is not present, the default value of 0 is used.

RTP Octet 2

| Type | Length | Value |
|---|---|---|
| 4 | 1 | bits 0-6: value of the payload type field in the RTP |
| | | header |
| | | bit 7: reserved |

This field carries the fixed part of the second octet of the RTP header. This field must be present if the RTP Octet 2 field is being suppressed. The marker bit must be restored from the PHS Control Field.

RTP Sequence Number Restoration

| Type | Length | Value |
|---|---|---|
| 5 | 1 | The value of the bits indicates the scheme for restoring |
| | | the RTP Sequence Number field, as shown in Table 2, |
| | | below. |

TABLE 2

| TLV | | |
|---|---|---|
| Type 5 | | |
| Value | Initial Packet | Subsequent Packets |
| 0 | Use any arbitrary starting value | Increment field (as 16-bit) |
| | for bits 4-15 and set bits 0-3 | counter) to keep bits 0-3 |
| | equal to the Continuity Counter | equal to the Continuity |
| | in the PHS Control Field | Counter in the PHS Control |
| | | Field |
| 1 | Use value from refresh field if | Use value from refresh field if |
| | available, otherwise use any | available, otherwise increment |
| | arbitrary starting value for bits | field (as 16-bit counter) to |
| | 4-15 and set bits 0-3 equal to | keep bits 0-3 equal to the |
| | the Continuity Counter in the | Continuity Counter in the |
| | PHS Control Field | PHS Control Field |

The RTP Special Mode in the PHS Control Field supercedes the normal incrementing defined in this field.

This field specifies the actions to be taken by the decompression decoder to restore the suppressed RTP Sequence Number Field. If not present, the default value of 0 is used. Note that the RTP Special Mode in the PHS Control Field supercedes the normal incrementing defined in this field.

RTP Timestamp Restoration

| Type | Length | Value |
|---|---|---|
| 6 | 3 | The value of the bits indicates the scheme for restoring |
| | | the RTP Timestamp field, as shown in Table 3, below. |

TABLE 3

| TLV | | |
|---|---|---|
| Type 6 | | |
| Value | Initial Packet | Subsequent Packets |
| 0 | Use arbitrary starting value. | Increment field (as 32-bit |
| | | counter) by value in Octets 2-3 |
| | | of TLV Type 6. |
| 1 | Use arbitrary starting value. | Increment field (as 32-bit |
| | | counter) by value in Octets 2-3 |
| | | of TLV Type 6 in packets |
| | | immediately following packet |
| | | with Marker bit set. Leave |
| | | values in other packets |
| | | unchanged. |
| 2 | Use 16-bit value from refresh | Increment field (as 32-bit |
| | field if available and use | counter) by value in Octets 2-3 |
| | arbitrary value for the other | of TLV Type 6. If a 16-bit value |
| | 16 bits. Otherwise use arbi- | is available from the Refresh |
| | trary value for full 32 bits. | Field, then use it to overwrite |
| | | those 16 bits. |
| 3 | Use 16-bit value from refresh | Increment field (as 32-bit |
| | field if available and use | counter) by value in Octets 2-3 |
| | arbitrary value for the other | of TLV Type 6 in packets that |
| | 16 bits. Otherwise use arbi- | immediately follow a packet |
| | trary value for full 32 bits. | with the Marker bit set. Leave |
| | | values in other packets |
| | | unchanged. |

The compression encoder determines which fields need refreshing and sets up a schedule for generating the needed refresh fields and inserting them into the packets.

The IP Identification field must be refreshed if TLV Type 3 has value=1.

The RTP Sequence Number field must be refreshed if TLV Type 5 has value=1.

The RTP Timestamp field must be refreshed if TLV Type 6, Octet 1 has value=2 or 3.

The PHS Control Field has one octet, and preferably is placed immediately before the RTP data in the transmitted information packet. Alternatively, this field is placed at the beginning of the DOCSIS PHS mask region. This field consists of:

| | |
|---|---|
| Bits 0-3 | 4-bit packet continuity counter |
| Bits 4-6 | Refresh Control Field |
| Bit 7 | Marker bit from RTP Octet 2, or unused. |

Bit 0 is the LSB of the field. If RTP Octet 2 is being suppressed, the Marker bit is carried in bit 7 of this field. Otherwise, bit 7 is not used.

The Refresh Control Field indicates the presence of a Refresh Field and its contents as shown in the Table 4 below. If present, the Refresh Field immediately follows the PHS Control Field. Only one Refresh Field can be carried in each information packet.

TABLE 4

| Refresh Control Field | Refresh Field Size | Refresh Field Contents |
|---|---|---|
| 0 | 0 | No Refresh Field |
| 1 | 2 octets | RTP Sequence Number |
| 2 | 2 octets | RTP Timestamp bits 0-15 |
| 3 | 2 octets | RTP Timestamp bits 16-31 |
| 4 | 2 octets | IP Identification Field |
| 5 | 2 octets | RTP Special Mode |
| 6-7 | 0 | Reserved codes - no |
| | | Refresh Field |

When no Refresh Field is needed, the Refresh Control Field is set to zero.

When UDP Checksums are carried in the payload header of the information packets, Refresh Fields of two octets are used to periodically refresh the actual values of the RTP Sequence Number field and the RTP Timestamp field because these two fields are covered by the UDP Checksum. For codecs using silence suppression, these two fields must be conveyed in the first packet of a talk burst. However, in accordance with the predetermined suppression algorithm both of these two fields cannot be suppressed from the payload header of a discrete information packet. For continuous voice codecs, it may be acceptable to have a short synchronization interval at the start of the connection wherein the decoder discards packets with bad UDP Checksums, which occur when the decompression decoder does not have the values of these two fields. In the absence of errors, these two fields are sent to the decompression decoder using the Refresh Fields in the first three packets (30 ms for 10 ms packetization) and then the decompression decoder is able to produce packets with good UDP checksums. During a given connection, if an error occurs and the compression encoder and decompression decoder become unsynchronized, the error is cleared in no more than three packets. If the IP Identification field is also being refreshed, then the resynchronization time may be extended to four packets.

When IP Header Checksums are carried in the payload header of the information packets, a Refresh Field of two octets is used to periodically refresh the actual value of the IP Identification field, which is covered by the IP Header checksum. Otherwise most applications permit calculation of the IP Header Checksum at the decompression decoder.

The RTP Special Mode field is used when there is a discontinuity in the normal regular incrementing patterns of the RTP Sequence Number field and RTP Timestamp field. In this mode the contents of the Refresh Field contain two integers. The first octet contains the number (0 to 255) by which the RTP Sequence Number should be incremented for this packet. The second contains an integer (−128 to 127) by which the normal RTP Timestamp field increment (in TLV Type 6, Octets 2-3) should be multiplied to calculate the change in RTP Timestamp field to be applied for this packet.

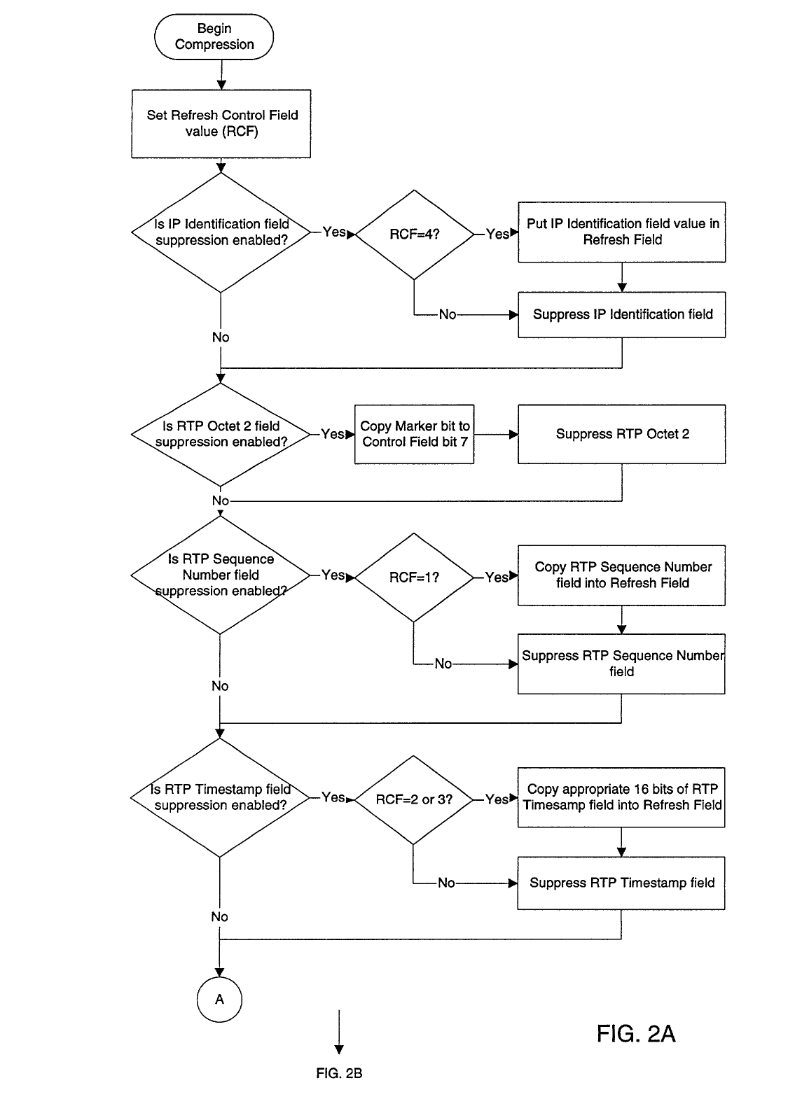

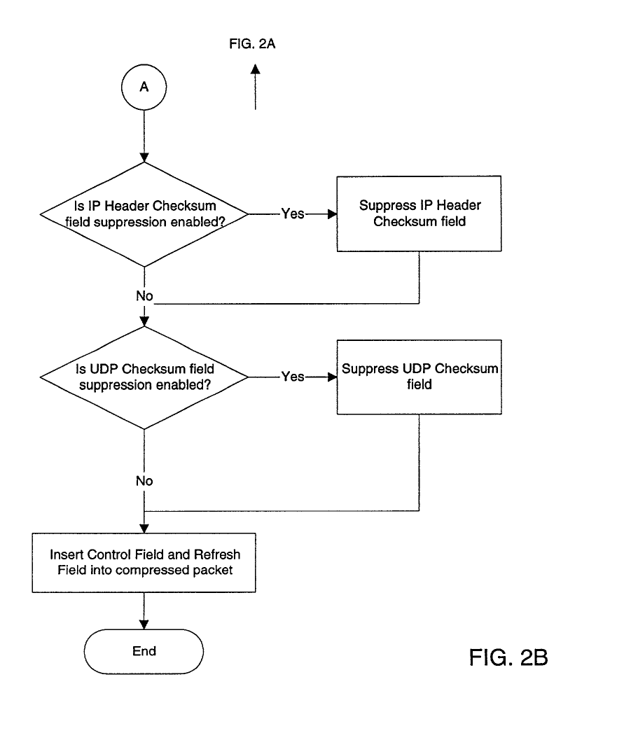

The preferred order of compression of the payload header is such that first the fixed value fields are suppressed in accordance with the prior art DOCSIS PHS scheme, and then the predetermined suppression algorithm is used to suppress the variable value fields. Alternatively, the variable value fields are suppressed before the fixed value fields. The TLV Type 1 version 0x03 value has been reserved for this alternative ordering of suppression. The compression encoder accesses the DOCSIS PHS Mask and Size fields to locate the bytes to be suppressed. The predetermined suppression algorithm is shown in FIGS. 2A and 2B.

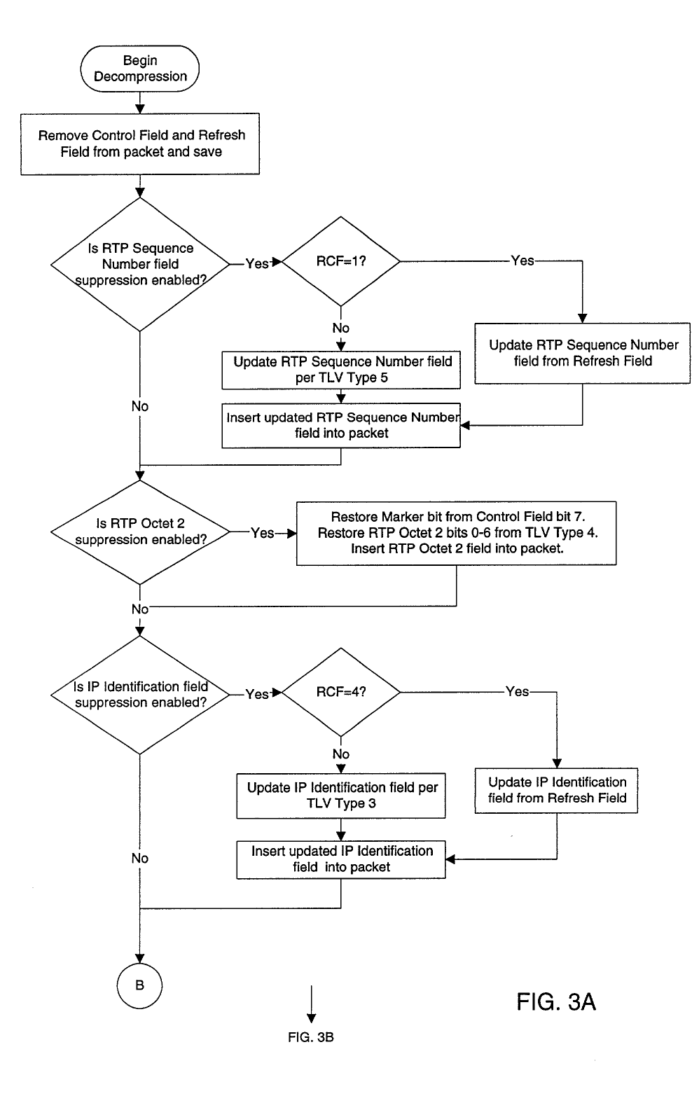

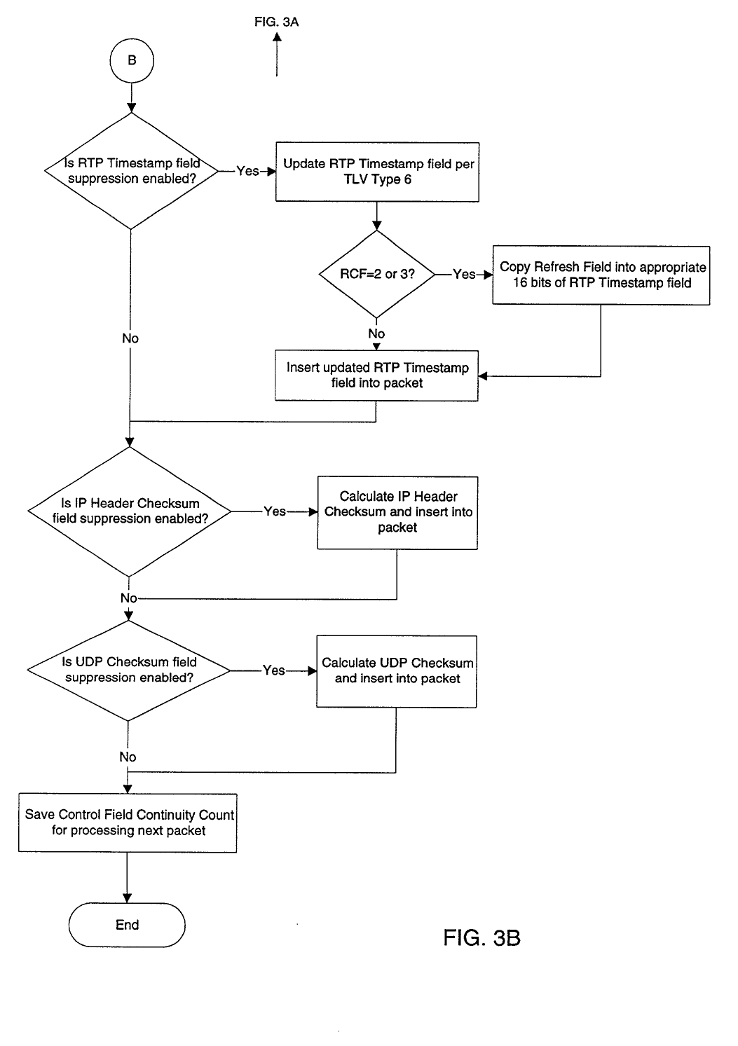

The preferred order of decompression of the payload header is such that first the predetermined restoration algorithm is used to restore the variable value fields, and then the fixed value fields are restored in accordance with the prior art DOCSIS PHS scheme. Alternatively, the fixed value fields are restored before the variable value fields. The decompression decoder accesses the DOCSIS PHS Mask and Size fields to locate the bytes to be restored and accesses the DOCSIS PHS Field to obtain values of suppressed octets to calculate the IP Header Checksum and the UDP Checksum. The predetermined restoration algorithm is shown in FIGS. 3A and 3B.

With reference to the predetermined restoration algorithm, the respective variable fields are restored and inserted into the payload header of the decompressed information packets in accordance with the value of the Refresh Control Field shown in Table 4 and the TLV value of the related field type as defined in the above-described PHS encoding extensions.

The IP Identification field is restored according to the scheme indicated by the value of the TLV Type 3 encoding extension, as set forth in Table 1 above.

The RTP Octet 2 field is restored by taking bits 0-6 from the TLV Type 4 encoding extension, and taking the Marker bit from the PHS Control Field.

The RTP Sequence Number field is restored according to the scheme indicated by the value of the TLV Type 5 encoding extension, as set forth in Table 2 above.

The RTP Timestamp field is restored according to the scheme indicated by the value of the TLV Type 6 encoding extension, as set forth in Table 3 above.

The IP Checksum field is restored by calculation. It may be necessary to obtain some of the needed values from the DOCSIS PHS Field.

The UDP Checksum field is restored by calculation. This field cannot be calculated until the RTP Header has been reconstructed. It may be necessary to obtain some of the needed values from the DOCSIS PHS Field.

The major constraint on the upstream link is that, for efficient use of UGS, the length of the compressed packet must not vary significantly. This limits the upstream link to using only techniques that do not require that an uncompressed header be sent periodically (as do all the RFC methods).

All the compression methods for the preferred embodiments described herein are for simplex links (no feedback from the decompression decoder to the compression encoder). Although this simplifies the protocol, the addition of feedback messages may make recovery faster for some errors.

Because a CMTS terminal may be supporting many customer CM terminals (and hence many calls) it is necessary to keep the algorithms simple to avoid overloading the CMTS terminal processor(s). It may be acceptable to calculate the IP header checksum at the CMTS terminal, but it is less likely to be acceptable to recalculate the UDP checksum. Also, keeping the UDP checksum intact from end to end is an important network maintenance principle for some network operators. Nevertheless, the design supports both options—they can be applied independently.

The particular features of the embodiments described herein and advantages specifically stated herein do not necessarily apply to every conceivable embodiment of the present invention. Further, such stated advantages of the present invention are only examples and should not be construed as the only advantages of the present invention.

While the above description contains many specificities, these should not be construed as limitations on the scope of the present invention, but rather as examples of the preferred embodiments described herein. Other variations are possible and the scope of the present invention should be determined not by the embodiments described herein but rather by the claims and their legal equivalents.

### ACRONYM GLOSSARY

CID—Context Identifier

CM—Cable Modem

CMTS—Cable Modem Termination System

CRC—Cyclical Redundancy Check

DOCSIS—Data Over Cable Service Interface Specifications (maintained by Cable Television Laboratories, Inc. at www.cablemodem.com/specifications.html)

IP—Internet Protocol as defined in RFC-791

PHS—Payload Header Suppression

RFC—Request For Comment (maintained by the Internet Engineering Task Force at www.ietf org/rfc.html)

RTP—Real-time Transport Protocol as defined in RFC-1889

TLV—Type Length Value

VoIP—Voice-over-Internet Protocol

UDP—User Datagram Protocol as defined in RFC-768

UGS—Unsolicited Grant Service

WAN—Wide Area Network

1. A system for compressing and decompressing information packets transmitted from a first terminal to a second terminal, comprising
suppression means in the first terminal adapted to use a predetermined suppression algorithm for removing at least one field that varies in a known pattern from a payload header of an information packet being transmitted to the second terminal; and
restoration means in the second terminal adapted to use a predetermined restoration algorithm for restoring the removed at least one field that varies in the known pattern to the payload header of an information packet received from the first terminal;
wherein the first and second terminals respectively include means for processing and exchanging service control messages that include encoding extensions identifying the removed at least one field that varies in the known pattern and indicating a scheme for restoring the identified at least one field; and
wherein for discrete transmitted information packets, the predetermined restoration algorithm includes the step of:
(a) restoring the at least one identified removed field that varies in the known pattern in accordance with the scheme for restoring the identified at least one field indicated by the encoding extensions.

2. A system according to claim 1, wherein the suppression means is further adapted to use a predetermined suppression routine for removing fields having a fixed value from the payload header of the information packets being transmitted to the second terminal;
wherein the restoration means is further adapted to use a predetermined restoration routine that is complementary to the predetermined suppression routine for restoring the removed fixed-value fields to the payload header of information packets received from the first terminal; and
wherein the predetermined suppression routine, the predetermined restoration routine and the service control messages are in accordance with a DOCSIS payload-header-suppression (PHS) specification.

3. A system according to claim 1, wherein step (a) includes the step of:
(b) from time to time restoring the removed field by using an associated refresh field received with the information packet.

4. A system according to claim 3, wherein for discrete information packets, the predetermined suppression algorithm includes the steps of:
(c) providing a refresh control field identifying a refresh field that is to be transmitted with the discrete information packet;
(d) providing the refresh field identified by the refresh control field for transmission to the second terminal with the discrete information packet; and
(e) providing a control field that includes the refresh control field for transmission to the second terminal with the discrete information packet.

5. A system according to claim 4, wherein for discrete transmitted information packets, the predetermined restoration algorithm further includes the step of:
(f) in accordance with the refresh control field received with the discrete information packet, identifying the associated refresh field received with the discrete information packet.

6. A system according to claim 1, wherein one of the encoding extensions indicates a fixed partial value of a given field that is to be removed by the suppression means; and
wherein for discrete information packets, the predetermined suppression algorithm includes the step of:
(b) providing a variable remaining portion of the removed given field for transmission with the discrete information packet; and
wherein for discrete transmitted information packets, the predetermined restoration algorithm further includes the step of:
(c) restoring the removed given field by using the variable remaining portion of the removed given field received with the discrete information packet in combination with the fixed partial value of the given field.

7. A system according to claim 1, wherein the suppression means provides constant-length compressed information packets for transmission to the remote terminal.

8. A system for compressing and decompressing information packets transmitted from a first terminal to a second terminal, comprising
suppression means in the first terminal adapted to use a predetermined suppression algorithm for removing at least one field that varies in a known pattern from a payload header of an information packet being transmitted to the second terminal; and
restoration means in the second terminal adapted to use a predetermined restoration algorithm for restoring the removed at least one field that varies in the known pattern to the payload header of an information packet received from the first terminal;
wherein the predetermined restoration algorithm includes the step of:
(a) from time to time restoring the at least one removed field that varies in the known pattern by using an associated refresh field received with the information packet.

9. A system according to claim 8, wherein for discrete information packets, the predetermined suppression algorithm includes the steps of:
(b) providing a refresh control field identifying a refresh field that is to be transmitted with the discrete information packet;
(c) providing the refresh field identified by the refresh control field for transmission to the second terminal with the discrete information packet; and
(d) providing a control field that includes the refresh control field for transmission to the second terminal with the discrete information packet.

10. A system according to claim 9, wherein for discrete transmitted information packets, the predetermined restoration algorithm further includes the step of:
(e) in accordance with the refresh control field received with the discrete information packet, identifying the associated refresh field received with the discrete information packet.

11. Apparatus for compressing information packets for transmission to a remote terminal, comprising
suppression means adapted to use a predetermined suppression algorithm for removing at least one field that varies in a known pattern from a payload header of an information packet being transmitted to the remote terminal; and
means for processing and exchanging service control messages with the remote terminal, wherein the service control messages include encoding extensions identifying the removed at least one field that varies in the known pattern and indicating a scheme for restoring the identified at least one field;
wherein the suppression means provides constant-length compressed information packets for transmission to the remote terminal.

12. Apparatus according to claim 11, wherein the suppression means is further adapted to use a predetermined suppression routine for removing fields having a fixed value from the payload header of the information packets being transmitted to the remote terminal; and
wherein the predetermined suppression routine and the service control messages are in accordance with a DOCSIS payload-header-suppression (PHS) specification.

13. Apparatus according to claim 11, wherein one of the encoding extensions indicates a fixed partial value of a given field that is to be removed by the suppression means; and
wherein for discrete information packets, the predetermined suppression algorithm includes the step of:
(a) providing a variable remaining portion of the removed given field for transmission to the remote terminal with the discrete information packet.

14. Apparatus for compressing information packets for transmission to a remote terminal, comprising
suppression means adapted to use a predetermined suppression algorithm for removing at least one field that varies in a known pattern from a payload header of an information packet being transmitted to the remote terminal;
wherein for discrete information packets, the predetermined suppression algorithm includes the steps of:
(a) providing a refresh control field identifying a refresh field that is to be transmitted with the discrete information packet;
(b) providing the refresh field identified by the refresh control field for transmission to the remote terminal with the discrete information packet; and
(c) providing a control field that includes the refresh control field for transmission to the remote terminal with the discrete information packet.

15. Apparatus for decompressing transmitted information packets received from a remote terminal, comprising
restoration means adapted to use a predetermined restoration algorithm for restoring a removed at least one field that varies in a known pattern to the payload header of an information packet received from the remote terminal;
means for processing and exchanging service control messages with the remote terminal, wherein the service control messages include encoding extensions identifying the removed at least one field that varies in the known pattern and indicating a scheme for restoring the identified at least one field; and
wherein for discrete transmitted information packets, the predetermined restoration algorithm includes the step of:
(a) restoring the at least one identified removed field that varies in the known pattern in accordance with the scheme for restoring the identified at least one field indicated by the encoding extensions.

16. Apparatus according to claim 15, wherein step (a) includes the step of:
(b) from time to time restoring the removed field by using an associated refresh field received with the information packet.

17. Apparatus according to claim 16, wherein for discrete transmitted information packets, the predetermined restoration algorithm further includes the step of:
(c) in accordance with a refresh control field received with the discrete information packet, identifying the associated refresh field received with the discrete information packet.

18. Apparatus according to claim 15, wherein one of the encoding extensions indicates a fixed partial value of a given field that is removed by the suppression means; and
wherein for discrete information packets, the predetermined restoration algorithm further includes the step of:
(c) restoring the removed given field by using a variable remaining portion of the removed given field received with the discrete information packet in combination with the fixed partial value of the given field.

19. Apparatus for decompressing transmitted information packets received from a remote terminal, comprising
restoration means adapted to use a predetermined restoration algorithm for restoring a removed at least one field that varies in a known pattern to the payload header of an information packet received from the remote terminal;
wherein the predetermined restoration algorithm includes the step of:
(a) from time to time restoring the at least one removed field that varies in the known pattern by using an associated refresh field received with the information packet.

20. Apparatus according to claim 19, wherein for discrete information packets, the predetermined restoration algorithm further includes the step of:
(b) in accordance with a refresh control field received with the discrete information packet, identifying the associated refresh field received with the discrete information packet.
